(19) United States
(12) Patent Application Publication
(10) Pub. No.: US 2006/0027651 A1
(43) Pub. Date: Feb. 9, 2006

(54) Flight identification system and method of determining flight identification using mode-S address

(76) Inventor: Richard R. Berckefeldt, Paola, KS (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/912,854

(22) Filed: Aug. 6, 2004

(51) Int. Cl. G07B 15/02

(52) U.S. Cl. 235/384

(57) ABSTRACT

Methods and apparatus are provided for determination of flight identification using Mode-S transponders. A method of flight identification determination includes the steps of determining a Mode-S address within a desired range of Mode S Addresses, reverse transforming the Mode-S address to an original registration number, storing the original registration number in a memory location, and transmitting the registration number, used as an ICAO Flight ID, from the memory location upon ground interrogation.

### FIELD OF THE INVENTION

The present invention generally relates to identification of aircraft, and more particularly relates to determining flight identification using transponders.

### BACKGROUND OF THE INVENTION

The International Civil Aviation Organization (ICAO) has assigned groupings of Mode S addresses to each respective country such that no two countries have duplicate numbers. Each country in turn assigns unique numbers within its assigned range for each aircraft equipped with a Mode-S Transponder. Some countries have assigned these Mode-S addresses, on a first-come-first-serve, or sequential basis to each aircraft. Other countries, including the U.S., have assigned these numbers based on a predefined formula This formula transforms the aircraft's registration number into a 24-bit Mode-S address. The formula is designed in such a way as to generate a number that falls within the range of numbers assigned to that country by ICAO.

In a Mode-S system, a ground station transmitter/receiver typically interrogates aircraft discretely based on a specific 24-bit address assigned to each aircraft. The ground station transmits a Mode-S interrogation to each aircraft from which a reply is sought. The Mode-S protocol was developed to operate within an existing Mode-A or Mode-C environment. Each Mode-S transponder is assigned a unique address for communication by the transponder. This allows for multiple flight communication to occur since each transponder may be separately and selectively interrogated by ground control.

Mode-S transponders generally provide aircraft information such as altitude, Mode A codes, and various other flight information, when properly interrogated. In operation, the unique 24-bit address code, or identity tag, is assigned to each aircraft in a surveillance area. This address, together with the aircraft's range and azimuth location, is entered into a file in the Mode S Ground Station or interrogator, commonly known as putting the aircraft on roll-call, and the aircraft is thereafter discretely interrogated based on it's unique address. The aircraft is tracked by the interrogator throughout an assigned airspace and, during subsequent interrogations, the Mode-S transponder generally reports, in corresponding replies, either a current altitude or a Mode A code, depending upon the type of discrete interrogation received. As the Mode-S equipped aircraft moves from the airspace served by one Mode-S interrogator into the airspace served by another Mode-S interrogator, the aircraft's location information and discrete address code may be passed on via landlines or a Mode-S transponder response to an All-Call interrogation signal broadcast by the next Mode-S interrogator.

The unique 24-bit address code allows a very large number of aircraft to operate in the air traffic control environment while substantially minimizing an occurrence of synchronous garble. Interrogations that are directed to a particular aircraft using this unique address code and the corresponding replies are identified with minimum ambiguity. The unique address coded into each interrogation and reply also permits inclusion of data link messages to and/or from a particular aircraft.

Additionally, many European countries require some aircraft operators to equip aircraft and operate the same with Mode S transponders having certain desired features. For example, the transponder may be required to contain a call sign or Flight ID for the aircraft, and transmission of this Flight ID may be required in the form of a reply when properly interrogated, such as by a ground controller or interrogator. This is commonly termed “elementary surveillance.” Elementary surveillance generally requires that an aircraft, with a Mode-S transponder, respond to a ground interrogation with a Flight ID, which is typically a radio call sign associated with the aircraft. For many aircraft, the radio call sign is the registration number associated with the aircraft.

Using a Mode-S transponder, a particular aircraft can provide an ICAO Flight ID when requested while minimizing interference or communication that may otherwise occur with multiple flight communications. Typically, aircraft operators, such as a pilot, co-pilot, or flight engineer, will key-in or dial-in the Flight ID for transmission by the Mode S transponders. This generally requires some action on the part of the aircraft operator. The pilot entered Flight ID is then transmitted by the Mode-S transponder.

Accordingly, it is desirable to provide a method of flight identification that minimizes aircraft operator actions. It is also desirable to provide a flight identification system that automatically provides a Flight ID without action by the aircraft operator. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Systems, methods, and apparatus are provided for flight identification. In a first exemplary embodiment, a method of flight identification includes the steps of determining if a Mode-S address is within a desired range of Mode-S addresses, reverse transforming the Mode-S address to an original registration number, storing the original registration number in a memory location, and transmitting the registration number as an ICAO Flight ID from the memory location upon ground interrogation.

In a second exemplary embodiment, a flight identification system comprises a data storage device, a receiver configured to receive ground control interrogation signals, a processor coupled to the receiver and the data storage device, and a transmitter coupled to the processor. The processor is configured to read a predefined address, derive a registration number from the predefined address, and store the registration number in the data storage device. The transmitter is configured to transmit the registration number from the data storage device.

In a third exemplary embodiment, a transponder having a statically assigned Mode-S address and includes a receiver configured to receive air traffic communication signals from an air traffic controller, a processor coupled to the receiver, a modulator/demodulator coupled to the receiver and the processor, and a transmitter coupled to the processor and modulator/demodulator. The processor includes a register and is configured to identify the Mode-S address, reverse transform the Mode-S address to obtain a registration number, and store the registration number in the register. The modulator/demodulator is configured to demodulate the air traffic communications signals and output a data signal formatted in accordance with a predefined mode of communication, and modulate a transmit signal in accordance with the predefined mode of communication. The transmitter is configured to transmit the registration number in the transmit signal.

In a fourth exemplary embodiment, an aircraft radio having an assigned Mode-S address, the radio comprising a transceiver configured to transmit and receive air traffic communication signals from an interrogator, an operating system configured to read the Mode-S address and reverse transform the Mode-S address to obtain a registration number, a processor coupled to the transceiver, and a data storage device coupled to the processor. The processor is configured to execute the operating system. The operating system is further configured to store the registration number in the data storage device upon execution by the processor. The transceiver is further configured to transmit the registration number upon a proper interrogation or as an unsolicited transmission, such as a periodically transmitted “squitter”.

### BRIEF DESCRIPTION OF THE DRAWINGS

The present invention will hereinafter be described in conjunction with the following drawing figures, wherein like numerals denote like elements, and

FIG. 1 is a block diagram of a transponder in accordance with an exemplary embodiment of the present invention; and

FIG. 2 is a flow diagram of a method of flight identification in accordance with an exemplary embodiment of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

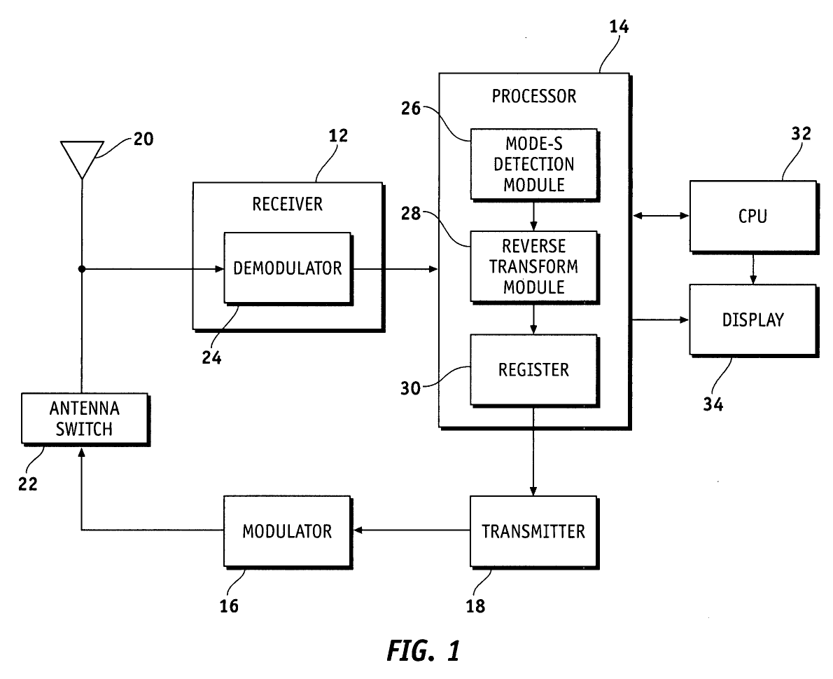

Referring to the drawings, FIG. 1 is a block diagram of a transponder 10 in accordance with an exemplary embodiment of the present invention. The transponder 10 includes a receiver 12, a processor 14 communicating with the receiver 12, and a transmitter 18 communicating with the processor 14. The transponder 10 may be coupled to an antenna 20 that is located on an aircraft (not shown) for sending and receiving air traffic communication signals. Although one antenna is shown, multiple antennas and antenna configurations, such as antenna arrays, may be used with the transponder 10. An antenna switch 22 may be coupled to the antenna 20 to control a transmit mode and a receive mode of transponder operation. A central processing unit (CPU) 32 and display 34 may optionally be coupled to the processor for retrieving additional flight data from the aircraft and displaying various flight information in the aircraft cockpit, respectively.

The receiver 12 includes a demodulator 24 that performs analog or digital signal processing on received air traffic communication signals. For example, the demodulator may perform differential phase shift keyed (DPSK) signal demodulation or various other signal demodulations. The transmitter 18 may be coupled to a modulator 16 that performs analog or digital signal processing on air traffic communication signals to be transmitted from the aircraft. Although the transponder 10 is shown to have a separate transmitter 18 and receiver 12, the transmitter 18 and receiver 12 may be combined into a single component of the transponder 10, such as in the example of a transceiver. The receiver 12 and transmitter 18 may also each include signal conditioning circuitry, such as to perform down- and up-conversion, respectively, although not shown.

Although the demodulator 24 and modulator 16 are shown to be separated, the demodulator 24 and modulator 16 may be combined into a single component. Additionally, the demodulator 24 may be a separate module from the receiver 12, and the modulator 16, may be integrated with the transmitter 18. Other variations and different embodiments of radio frequency (RF) architecture may also be selected for the transponder 10 as appreciated by those of skill in the art.

In one exemplary embodiment, the transponder 10 is a Mode-S transponder having a Mode-S address assigned thereto. The Mode-S address is provided to an aircraft owner upon application by the regulatory agency having jurisdiction in the aircraft's country of registry. In one exemplary embodiment, the Mode-S address is a 24-bit address that was derived from a pre-determined mathematical formula that produces a value within a range of values from a registration number or “tail” number associated with each aircraft. In many cases, the registration number or “tail” number is used as a call sign or ICAO Flight ID. The 24-bit Mode-S address is encoded into the installation of the transponder 10 such as by “program pins”, a configuration module containing non-volatile memory, or various other encoding methods. The range of values available for a particular Mode-S address is based on a particular desired country and was set forth by ICAO.

The processor 14 includes a Mode-S address detection module 26, a reverse transform module 28 coupled to the Mode-S address detection module 26, and one or more registers 30 coupled to the reverse transform module 28. At power-up of the Mode-S transponder 10, the encoded Mode-S address is read by the processor 14. For example, the Mode-S address is statically assigned to the transponder 10, such as by the aforementioned program pins, and the processor 14 reads the address therefrom. The processor 14 determines whether the Mode-S address is within a desired grouping of numbers, such as a range of sequential numbers assigned to a particular country for flight identification.

If the Mode-S address is not within the desired grouping of numbers, the processor 14 may compare the Mode-S address to a different grouping of numbers that are associated with another country, and re-compare the Mode-S address therewith. If the Mode-S address is not within any of the available desired grouping of numbers, the determination of the registration number ends. If the Mode-S address is within the desired grouping, the processor 14 executes an inverse operation of the formula, or a transformation, for the Mode-S address and obtains an aircraft registration number (e.g., an N number in the U.S.). In one exemplary embodiment, this registration number is stored in the register 30 associated with the processor 14 for access by the processor 14 when prompted by a ground interrogation. The aforementioned processing of the Mode-S address is a transparent operation occurring within the transponder 10, and the aircraft operator is not required to manually input Flight ID because the registration number that is used as the call sign is determined and transmitted upon an appropriate ground interrogation generally without operator assistance.

Although the transformed registration number is described with regard to being stored in a register, the registration number may be stored in various types of memory locations, such as a designated memory location for recall in response to ground interrogation. For example, a separate data storage device (not shown), such as a hard drive, may be coupled to the processor 14 having a designated memory location for storage and retrieval of the registration number as well as having look-up tables that are accessible by the processor 14 for retrieving different ranges of registration numbers.

Communication between the aircraft and ground station follows known air traffic communication techniques. For example, the aircraft and ground station may operate asynchronously with respect to one another since the aircraft transponder 10 is generally driven by a separate internal clock (not shown) that operates independent of a clock used to drive the ground station transmitter/receiver. In this case, the processor 14 first synchronizes incoming received signals with the clock of the aircraft transponder 10 before reading the data contained within the communication of the Mode-S signals. Signals received at the aircraft transponder 10 may represent a collection of signals transmitted from different sources, for different purposes and in varied formats. The processor 14 searches the collective incoming signals for various identifiers, such as Mode-A, Mode-C, and Mode-S indicators. Typically, the Mode-S signal is identified by a corresponding preamble. In one exemplary embodiment, various pre-formatted message types are used with Mode-S, such as Uplink Formats (UF) and Downlink Formats (DF). When the transponder 10 detects a valid Mode-S preamble, the processor 14 then synchronizes with the ground station by known air traffic communication techniques. For example, interrogators may interrogate with a UF4 message, and the transponder 10 would reply with a DF4 reply.

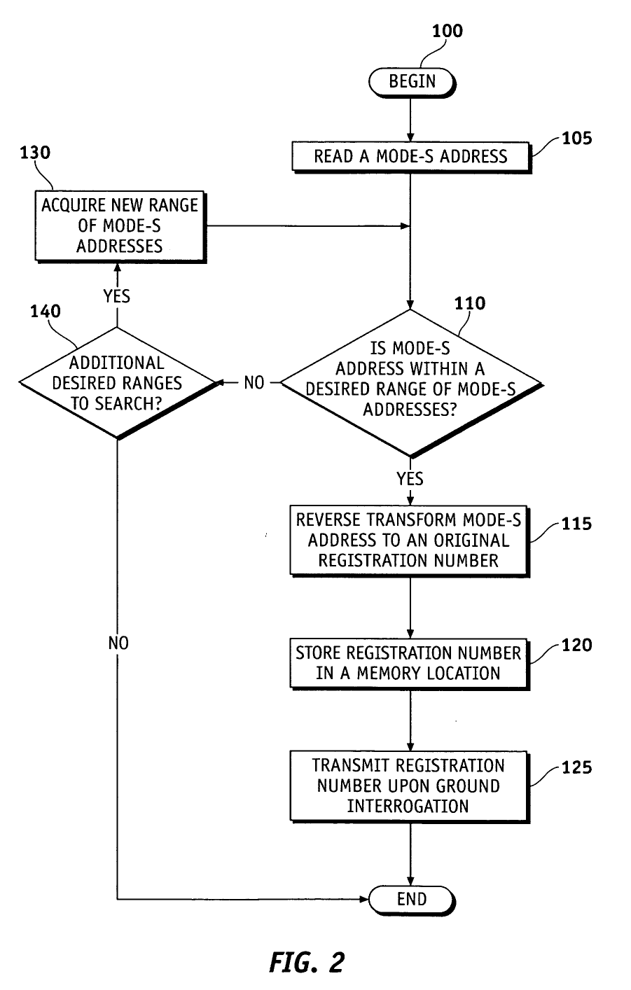

FIG. 2 is a flow diagram of a method of flight identification in accordance with an exemplary embodiment of the present invention. The method begins at step 100. The processing unit reads a Mode-S address at step 105. For example, in the transponder 10 (FIG. 1) during start-up, the processor 14 (FIG. 1) of the transponder 10 (FIG. 1) reads a corresponding Mode-S address.

The Mode-S address of the transponder 10 (FIG. 1) is compared with a range of Mode-S addresses at step 110 by the processor 14 (FIG. 1). The desired range of Mode-S addresses corresponds to the Mode-S addresses that are assigned to a particular country.

If the Mode-S address is not within the desired range of Mode-S addresses, the processor 14 (FIG. 1) determines if other additional desired ranges are available for searching at step 140.

If additional desired ranges are available for searching, a new range of Mode-S addresses is acquired by the processor 14 (FIG. 1) and is compared with the Mode-S address at step 130. For example, in the event the Mode-S address is not associated with a desired range of Mode-S addresses for a particular country, another desired range of Mode-S addresses for another country is compared with the Mode-S address to determine if a registration number can be determined that may be associated with the Mode-S address. If the Mode S address does not fall within any of the ranges of interest, then the process ends and no automatic determination of a registration number is made.

If the Mode-S address is within the desired range of Mode-S addresses for a particular country, a reverse transform of the Mode-S address is determined at step 115 by the processor 14 (FIG. 1). The result of the reverse transform is an original registration number associated with the aircraft. In one exemplary embodiment, the Mode-S address was derived by processing the original registration number through a pre-determined formula, such as established by the relevant administrative agency as previously discussed hereinabove. The results of the pre-determined formula are numbers or values occurring within the assigned range of Mode-S addresses for a particular country as set forth by ICAO.

The derived registration number is stored in a memory location, such as the register 30 shown in FIG. 1, at step 120. The register 30 (FIG. 1) is used for storing the registration number for most transponder systems where ground interrogation specifically requests transmission of the contents of a pre-determined register. This embodiment is ideally suited for use in current aircraft communication systems and air traffic control systems where uniformity is desirable. In alternative systems, various other data storage devices may be used, such as a dedicated memory location.

The registration number is transmitted by the transmitter 18 (FIG. 1) when ground interrogation requests Flight ID at step 125. For example, the ground interrogation may request transmission of the contents of the register 30 (FIG. 1) storing the registration number.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method of determining a registration number of an aircraft for use as an International Civil Aviation Organization (ICAO) Flight Identification (ID), said method comprising the steps of:
determining if a Mode-S address is within a desired range of Mode-S addresses;
reverse transforming the Mode-S address to an original registration number;
storing the original registration number in a memory location; and
transmitting the registration number as an ICAO Flight ID from the memory location upon ground interrogation.

2. A method of determining flight identification according to claim 1, wherein said storing step comprises storing the original registration number in a register.

3. A method of determining flight identification according to claim 1, wherein said determining step comprises comparing the Mode-S address with a range of Mode-S addresses associated with a country.

4. A method of determining flight identification according to claim 2, wherein said transmitting step comprises transmitting a content of the register.

5. A method of determining flight identification according to claim 1, wherein the Mode-S address is derived from processing the registration number using a pre-determined formula that produces a value within a range of Mode-S addresses; and
wherein said reverse transforming step comprises processing the Mode-S address using an inverse of the pre-determined formula.

6. A system for determining flight identification, said system comprising:
a data storage device;
a receiver configured to receive ground control interrogation signals;
a processor coupled to said receiver and said data storage device, said processor configured to:
read a predefined address;
derive a registration number from said predefined address; and
store said registration number in said data storage device; and
a transmitter coupled to said processor, said transmitter configured to transmit said registration number from said data storage device.

7. A flight identification determination system according to claim 6, wherein said data storage device comprises a register.

8. A flight identification determination system according to claim 6 further comprising a demodulator configured to demodulate said ground control interrogation signals and output a data segment formatted in accordance with a predefined mode of communication.

9. A flight identification determination system according to claim 8, wherein said processor is further configured to analyze said ground control interrogation signals and identify a segment corresponding to said predefined mode of communication, said predefined mode of communication using said predefined address.

10. A flight identification determination system according to claim 6, wherein said predefined address is derived from a pre-determined formula that produces a value within a range of values from a registration number; and
wherein said processor is configured to derive said predefined address by processing said predefined address using an inverse of said pre-determined formula.

11. A flight identification determination system according to claim 6, wherein said predefined address is a Mode-S address, said Mode-S address within a range of Mode-S addresses corresponding to a country.

12. A transponder having a statically assigned Mode-S address, said transponder comprising:
a receiver configured to receive air traffic communication signals from an air traffic controller;
a processor coupled to said receiver, said processor comprising a register, said processor configured to:
read the Mode-S address;
reverse transform the Mode-S address to obtain a registration number; and
store said registration number in said register;
a modulator/demodulator configured to:
demodulate said air traffic communications signals and output a data signal formatted in accordance with a predefined mode of communication; and
modulate a transmit signal in accordance with said predefined mode of communication; and
a transmitter coupled to said processor, said transmitter configured to transmit said registration number in said transmit signal.

13. A transponder according to claim 12, wherein the Mode-S address is derived from a pre-determined formula that produces a value within a range of Mode-S addresses from a registration number.

14. A transponder according to claim 13, wherein said processor is configured to reverse transform said Mode-S address by processing said Mode-S address using an inverse of said pre-determined formula.

15. A transponder according to claim 12, wherein said predefined mode of communication uses said Mode-S address.

16. An aircraft radio having an assigned Mode-S address, said radio comprising:
a transceiver configured to transmit and receive air traffic communication signals from an interrogator;
an operating system configured to:
identify the Mode-S address; and
reverse transform the Mode-S address to obtain a registration number;
a processor coupled to said transceiver, said processor configured to execute said operating system; and
a data storage device coupled to said processor, said operating system further configured to store said registration number in said data storage device upon execution by said processor.

17. A radio according to claim 16, wherein the Mode-S address is derived from a pre-determined formula that produces a value within a range of Mode-S addresses from a registration number; and
wherein said processor is configured to execute a reverse transform modules to process the Mode-S address using an inverse of said pre-determined formula.

18. A radio according to claim 16, wherein said transceiver is further configured to transmit said registration number in response to an interrogation from said interrogator.

19. A radio according to claim 16, wherein said transceiver is further configured to transmit said registration number as a substantially periodic unsolicited transmission.

20. A radio according to claim 16, wherein said predefined mode of communication uses the Mode-S address.

21. A radio according to claim 16, wherein said data storage device is a register.
